(19) United States
(12) Patent Application Publication
(10) Pub. No.: US 2012/0161484 A1
(43) Pub. Date: Jun. 28, 2012

(54) WHEELCHAIR TILTING MECHANISM

(75) Inventor: Chen-Chang Huang, Chiayi County (TW)

(73) Assignee: TAIWAN AN I CO., LTD., Chiayi County (TW)

(21) Appl. No.: 12/979,860

(22) Filed: Dec. 28, 2010

(51) Int. Cl. A61G 15/04

(52) U.S. Cl. 297/311

(57) ABSTRACT

A wheelchair tilting mechanism includes a seat support provided with pivot members and guide bars; a wheel support provided with pivot pins, to which the pivot members are rotatably connected; and a control unit including handlebars, actuating levers, cylinders fixedly mounted to the wheel support, and push bars separately movably received in the cylinders with an end mounted on the wheel support and the other end articulated to linking elements and fixed to the guide bars. The actuating levers are located below the handlebars to connect to the seat support via the linking elements, and fastening devices are provided at joints of the seat support and the linking elements. A control valve is provided on each of the linking elements. The tilting mechanism can be manipulated to steplessly adjust a wheelchair seat to different angular positions, allowing a patient sitting on the wheelchair to change posture.

### FIELD OF THE INVENTION

The present invention relates to a wheelchair tilting mechanism, and more particularly to a wheelchair tilting mechanism that allows stepless adjustment of the seat of a wheelchair to different rearward angular positions.

### BACKGROUND OF THE INVENTION

A wheelchair is a very common medical aid mainly applied to a patient who is unable to move conveniently, so that the patient can sit on the wheelchair and move to different places with the help of a nurse. Alternatively, the patient sitting on the wheelchair can move the wheelchair to different places by pushing a handle on boosting wheels. Currently, there are wheelchairs of various types and models available in the market. These wheelchairs can be generally divided into two categories, namely, ordinary wheelchairs and sports wheelchairs. Generally speaking, the wheelchairs that can be easily purchased in the market are ordinary wheelchairs. The sports wheelchairs are more expansive compared to the ordinary wheelchairs and are usually customized.

With the population aging, the demands for wheelchairs increase quickly. Moreover, people demand for wheelchairs with advanced technical design and more functions. An elder sitting on the wheelchair over a long time tends to become tired and needs to sleep for a while. It would be much convenient to take care of the sleepy elder if the wheelchair can be directly adjusted to function like a bed. The nurses in hospitals and nursing homes can save a lot of efforts if the wheelchairs can be freely converted into a bed.

Most of the currently available wheelchairs have complicate structure and a large number of parts, and require a lot of efforts to manipulate. The seat and the backrest of the conventional wheelchair are not adjustable in their angle of inclination. For patients suffering from hypertension or other diseases, it is dangerous for them to maintain a fixed posture for a prolonged time because such condition tends to disadvantageously cause unstable blood pressure or constant high blood pressure to the patient.

It is therefore desirable to develop a wheelchair tilting mechanism to compensate the drawbacks of the conventional wheelchairs.

### SUMMARY OF THE INVENTION

A primary object of the present invention is to overcome the problems in using the conventional wheelchairs by providing a wheelchair tilting mechanism that has simple structure and can be effortlessly manipulated to steplessly adjust the seat of a wheelchair to different rearward angular positions. Therefore, a patient may comfortably sit or recline on the wheelchair according to his or her actual need. The wheelchair tilting mechanism enables efficient nursing and easily solves the problem that the aged or the patient requires frequent change in posture to sit or to lie down. Thus, the wheelchair with the tilting mechanism of the present invention is very suitable for use in home, hospital and nursing home.

The wheelchair tilting mechanism according to the present invention includes a seat support, a wheel support, and a control unit. The seat support is provided with pivot members and guide bars. The wheel support is provided with pivot pins, to which the pivot members are rotatably connected. The control unit includes handlebars, actuating levers, cylinders, and push bars. The actuating levers are located below the handlebars to connect to the seat support via linking elements, and fastening devices are provided at joints of the seat support and the linking elements. A control valve is provided on each of the linking elements. The push bars are separately movably received in the cylinders with an end mounted on the wheel support and the other end articulated to the linking elements and fixed to the guide bars. The cylinders are fixedly mounted to the wheel support.

In the wheelchair tilting mechanism of the present invention, the linking elements are steel cables.

In the wheelchair tilting mechanism of the present invention, the pivot members are respectively provided with a pivot hole, into which the pivot pins are extended.

In the wheelchair tilting mechanism of the present invention, the pivot pins are externally provided with screw threads, and the pivot members are respectively provided with a nut corresponding to the screw threads on the pivot pins.

With the above arrangements, when a user exerts an upward force to push the actuating levers, the steel cables are moved to open the control valves and cause the push bars to be extendable from the cylinders. The user may then downward push the handlebars or a horizontal bar, so that the seat support is brought to pivotally turn about the pivot pins extended into the pivot holes on the pivot members and become tilted rearward. At this point, the push bars are brought to retract into the cylinders. When the seat support has been rearward tilted to a desired angular position, the actuating levers 12 can be released for the steel cables to bring the control valves to a closed state. By doing this, the seat support can be held to the tilted position. Neither the handlebars nor the horizontal bar can be downward pushed if the actuating levers are not upward pushed. Thus, the seat support can be steplessly adjusted to any desired tilting position. The wheelchair tilting mechanism according to the present invention allows a patient sitting on the wheelchair to change his or her posture, so as to help the patient to relieve his or her buttocks from too much pressure and over come the possible postural hypotension. The present invention also helps a patient suffering from hypertension to recover sooner.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view showing a wheelchair before a tilting mechanism of the present invention provided therewith is manipulated to tilt the wheelchair; and

FIG. 2 is a perspective view showing the wheelchair of FIG. 1 is tilted through manipulation of the tilting mechanism thereof.

### DETAILED DESCRIPTION OF THE PREFERRED EMBODIMENTS

The present invention will now be described with a preferred embodiment thereof and with reference to the accompanying drawings.

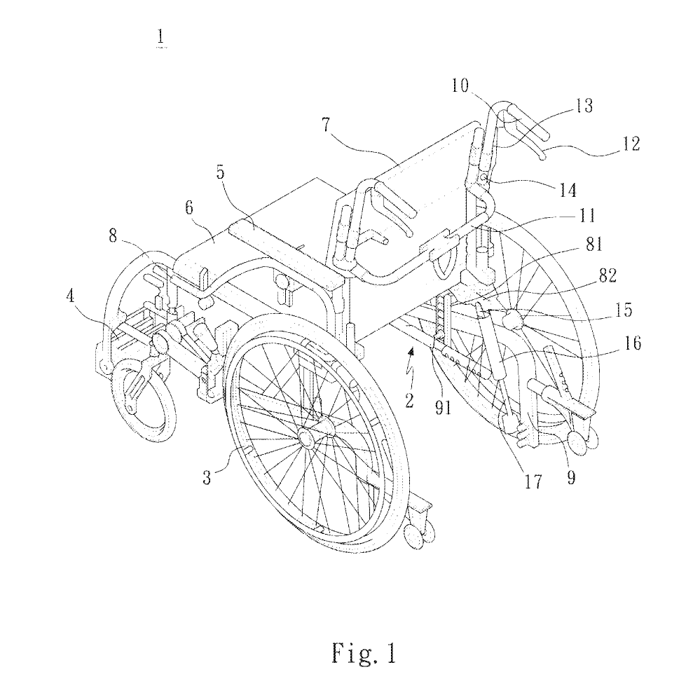

Please refer to FIG. 1, in which there is shown a wheelchair 1 having wheels 3, a braking device (not shown), a pair of footplates 4, two armrests 5, a seat 6, and a backrest 7. The wheelchair 1 is characterized by including a tilting mechanism 2 according to the present invention. The tilting mechanism 2 includes a seat support 8, a wheel support 9, and a control unit.

The seat 6 is mounted on the seat support 8. The backrest 7 is so disposed that an angle is contained between the backrest 7 and the seat 6, and the angle is adjustable through manipulating the tilting mechanism 2. A pair of handlebars 10 and a horizontal bar 11 are fixedly mounted behind the backrest 7. A pair of actuating levers 12 is located immediately below the pair of handlebars 10, and each of the actuating levers 12 is connected to the seat support 8 via a linking element 13. In a preferred embodiment of the present invention, the linking element 13 is a steel cable. A fastening device 14 is provided at a joint of the seat support 8 and each of the linking elements 13, and a control valve 15 is provided on each of the linking elements 13. The seat support 8 is provided at predetermined positions with a pair of pivot members 81 and a pair of guide bars 82. The wheel support 9 is provided at predetermined positions with a pair of pivot pins 91, to which the pivot members 81 are correspondingly rotatably connected. The pivot members 81 are respectively provided with a pivot hole (not shown), into which the pivot pins 91 are extended. The pivot pins 91 are externally provided with screw threads (not shown), and the pivot members 81 are provided with nuts (not shown) corresponding to the screw threads of the pivot pins 91. The control unit includes a pair of cylinders 16, a pair of push bars 17, and a pair of acting members (not shown). The cylinders 16 are fixedly mounted on the wheel support 9, and the push bars 17 are separately movably received in the cylinders 16. The push bars 17 respectively have an end fixedly connected to the wheel support 9 and another opposite end articulated to the linking elements 13 and fixed to the guide bars 82 via fastening devices 14.

With the above arrangements, when a user exerts an upward force to push the actuating levers 12, the steel cables 13 are moved to open the control valves 15 and cause the push bars 17 to be extendable from the cylinders 16. The user may then downward push the handlebars 10 or the horizontal bar 11, so that the seat support 8 is brought to pivotally turn about the pivot pins 91 extended into the pivot holes on the pivot members 81 and become tilted rearward. At this point, the push bars 17 are brought to retract into the cylinders 16. When the seat support 8 has been rearward tilted to a desired angular position, the actuating levers 12 can be released for the steel cables 13 to bring the control valves 15 to a closed state. By doing this, the seat support 8 can be held to the tilted position. Neither the handlebars 10 nor the horizontal bar 11 can be downward pushed if the actuating levers 12 are not upward pushed. Thus, the seat support 8 can be steplessly adjusted to any desired tilting position. The wheelchair tilting mechanism 2 according to the present invention allows a patient sitting on the wheelchair 1 to change his or her posture, so as to help the patient to relieve his or her buttocks from too much pressure and overcome the possible postural hypotension. The present invention also helps a patient suffering from hypertension to recover sooner.

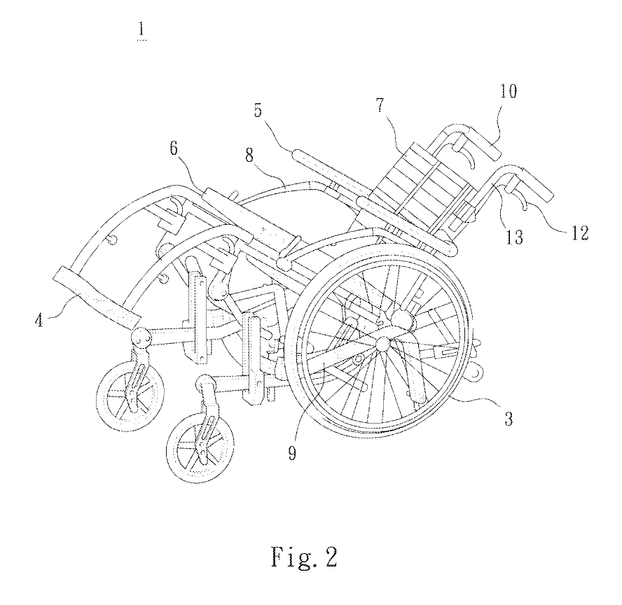

The procedures for a user to manipulate the wheelchair tilting mechanism 2 of the present invention are as follows. First, exert an upward force to push the actuating levers 12, so that the steel cables 13 are moved to open the control valves 15 and cause the push bars 17 to be extendable from the cylinders 16. Then, downward push the handlebars 10 or the horizontal bar 11, so that the seat support 8 is brought to pivotally turn about the pivot pins 91 extended into the pivot holes on the pivot members 81 and become tilted rearward. At this point, the push bars 17 are brought to retract into the cylinders 16. When the seat support 8 has been rearward tilted to a desired angular position, release the actuating levers 12 for the steel cables 13 to bring the control valves 15 to a closed state. By doing this, the seat support 8 can be held to the tilted position, as shown in FIG. 2. The handlebars 10 and the horizontal bar 11 could not be downward pushed if the actuating levers 12 are not upward pushed. Thus, the seat support 8 can be steplessly adjusted to any desired tilting position.

Further, to return the seat support 8 to its home position on the wheelchair 1, simply upward push the actuating levers 12, and the steel cables 13 are moved to open the control valves 15, which in turn causes the push bars 17 to extend from the cylinders 16. Then, push the handlebars 10 or the horizontal bar 11 upward for the seat support 8 to pivotally turn to another desired angular position or to its home position. Thereafter, release the actuating levers 12 to close the control valves 15. At this point, the push bars 17 would be held in place relative to the cylinders 16, and the seat support 8 would also be held to the desired position relative to the wheel support 9.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A wheelchair tilting mechanism, comprising a seat support, a wheel support, and a control unit; the seat support being provided at predetermined positions with a pair of pivot members and a pair of guide bars; the wheel support being provided with a pair of pivot pins, to which the pivot members are correspondingly rotatably connected; the wheelchair tilting mechanism being characterized in that:
the control unit includes a pair of handlebars, a pair of actuating levers, a pair of cylinders, and a pair of push bars; the actuating levers being located below the handlebars and being connected to the seat support via two linking elements with a fastening device provided at each of two joints of the seat support and the linking elements; the linking members respectively having a control valve provided thereon; the push bars being separately movably received in the cylinders, and respectively having an end fixedly connected to the wheel support and another opposite end articulated to the linking elements and fixed to the guide bars via fastening devices; and the cylinders being fixedly mounted to the wheel support.

2. The wheelchair tilting mechanism as claimed in claim 1, wherein the linking elements are steel cables.

3. The wheelchair tilting mechanism as claimed in claim 1, wherein the pivot members are respectively provided with a pivot hole, into which the pivot pins are extended.

4. The wheelchair tilting mechanism as claimed in claim 1, wherein the pivot pins are respectively externally provided with screw threads, and the pivot members are respectively provided with a nut corresponding to the screw threads on the pivot pins.
